(19) United States
(12) Patent Application Publication
(10) Pub. No.: US 2013/0136837 A1
(43) Pub. Date: May 30, 2013

(54) YELLOW ALUMINUM LAKE COMPOSITIONS

(71) Applicants: Jingang Shi, Beijing (CN); Hui Ma, Beijing (CN)

(72) Inventors: Jingang Shi, Beijing (CN); Hui Ma, Beijing (CN)

(73) Assignee: E.P.C. (Beijing) Plant Pharmaceutical Technology Co., Ltd, Beijing (CN)

(21) Appl. No.: 13/482,162

(22) Filed: May 29, 2012

Related U.S. Application Data
(60) Provisional application No. 61/492,920, filed on Jun. 3, 2011.

(51) Int. Cl. A23L 1/275

(52) U.S. Cl. CPC A23L 1/2756
USPC 426/540

(57) ABSTRACT

The invention describes novel aluminum plant yellow extract lakes that are not typical for an aluminum lake material.

### CROSS REFERENCE TO RELATED APPLICATIONS

This application claims priority from U.S. Provisional Patent Application No. 61/492,920 filed Jun. 3, 2011, entitled “YELLOW ALUMINUM LAKE COMPOSITIONS”, the contents of which are incorporated herein in it's entirety for all purposes.

### FIELD OF THE INVENTION

The invention relates generally to food coloring substances useful, for example in the manufacture of food products, sweets and pharmaceutical products.

### BACKGROUND OF THE INVENTION

Coloring substances containing natural or synthetic coloring substances are commonly used in the manufacturing of food products and pharmaceutical products. A wide range of synthetic coloring substances are commercially available making it possible for the manufacturer of food products, sweets and pharmaceutical products, where a particular color tone is desired, to select a single coloring substance having the desired color or a mixture of coloring substances, which in appropriate combination impart the desired color to the product.

FD& C Yellow Aluminum Lake is known to be a reproductive toxin and hazardous to the nervous system. Also known as tartrazine, it's a suspected cause of asthma, dermatitis, and other allergic and inflammatory responses.

FD& C Yellow Aluminum Lake can be found in eye shadow, blush, nail polish, mascara, lip balm, facial powder, lipstick, lip liner and sunscreens.

As the general population becomes more wary of non-natural dyes, colorants and pigments, new materials must be produced.

Therefore, a need exists for a natural yellow coloring that overcomes one or more of the current disadvantages noted above.

### BRIEF SUMMARY OF THE INVENTION

The present invention surprisingly provides coloring compositions, methods to prepare the color compositions and their use. The coloring compositions generally comprise a food coloring substance which includes a plant yellow extract and one or more of 1) an aluminum containing compound and a calcium containing compound; 2) an excess of aluminum containing compound relative to plant yellow extract; 3) an excess of aluminum containing compound relative to plant yellow extract with a calcium containing compound; 4) a ferric ion-containing compound and a plant yellow extract; 5) a ferric ion-containing compound, a plant yellow extract and a calcium containing compound; 6) an excess of ferric ion-containing compound relative to a plant yellow extract; 7) an excess of ferric ion-containing compound relative to a plant yellow extract with a calcium containing compound; 8) a plant yellow extract compound, a ferric ion-containing compound and an aluminum containing compound (either or both in excess relative to the plant yellow extract); 9) a plant yellow extract compound with an aluminum compound, optionally with a ferric ion-containing compound and/or a calcium compound (wherein one or more of the aluminum, ferric ion-containing compound or calcium compound can all be in excess relative to the plant yellow extract); 10) a purified plant yellow extract in the presence of one or more of an aluminum containing compound, a calcium containing compound and/or a ferric ion-containing compound, wherein one or more of the aluminum, calcium or ferric ion-containing compound can be in excess relative to the plant yellow extract; and 11) specific plant yellow extract components in the presence of one or more of an aluminum containing compound, a calcium containing compound and/or a ferric ion-containing compound, wherein one or more of the aluminum, calcium or ferric ion-containing compound can be in excess relative to the plant yellow extract.

Thus the present invention provides coloring compositions, methods to prepare the color compositions and their use. The coloring compositions generally comprise a food coloring substance which includes gardenia, saffron, or safflower. Safflower extract can be hydroxysafflor yellow A (safflomin A), or safflower yellow B (safflomin B). Gardenia extract or saffron extract can include crocin, a monoester of crocetin or a diester of crocetin, generally comprising one or more sugar moieties and genipin or geniposide.

In one aspect, the food coloring substance does not include a material that is an anthocyanin and does not include a flavylium cation.

In another aspect, the food coloring substance has a yellow color in the visible spectrum.

In yet another aspect, the yellow material includes a conjugated unsaturated or polyunsaturated hydrocarbon adjacent to a carbonyl moiety. The carbonyl moiety can be an ester, a carboxylic acid, a ketone, an enol form of a ketone or a phenol, such as those in safflomins, genipins, crocetin, etc.

In still another aspect, the conjugated hydrocarbon can have between 4 and about 40 carbon atoms, more particularly between 4 and about 20 carbon atoms, even more particularly between 4 and about 10 carbon atoms and most particularly between 4 and about 6 carbon atoms.

In yet another aspect, the conjugated hydrocarbon and carbonyl moiety can be an alpha, beta unsaturated ketone, for example, such as that found in genipin.

In still yet another aspect, the hydrocarbon backbone of the unsaturated or polyunsaturated hydrocarbon does not include one or more heteroatoms (e.g., O, P, N, S) within the hydrocarbon backbone.

A “conjugated” system is one wherein double bonds are adjacent to each other, such as for example, a 1, 3 butadiene. This is a known chemical term denoting double bonds separated from each other by a single bond. Conjugated systems are found in safflomins, crocetin, and genipin.

In one aspect, a food color is transformed from being water soluble into being water insoluble, where leaking and bleeding problems are circumvented.

It has been surprisingly found that addition of a calcium containing compound to an aluminum lake, for example, at low pH helps to precipitate the “yellow” (and desired) product at previously unattainable pH values (of from about 2 to 4) in aqueous solutions.

In another aspect, a plant yellow extract-aluminum lake is prepared by a procedure, whereby an aluminium containing compound is combined with the food coloring substance, followed by adjustment of the pH to a value of from about 2 to about 6, preferably from 5 to 6, to cause precipitation of the lake, optionally in the presence of a calcium compound or a ferric ion-containing compound.

Also surprisingly, it has been found that the desire and need mentioned above can be met by preparation of an aluminium lake of the food colorant. The aluminum lake may be prepared by combining an aluminum containing compound with the food coloring substance, followed by adjustment of the pH to a value of from about 2 to about 6, preferably from about 3 to about 5, to cause precipitation of the lake.

While multiple embodiments are disclosed, still other embodiments of the present invention will become apparent to those skilled in the art from the following detailed description. As will be apparent, the invention is capable of modifications in various obvious aspects, all without departing from the spirit and scope of the present invention. Accordingly, the detailed descriptions are to be regarded as illustrative in nature and not restrictive.

### BRIEF DESCRIPTION OF THE DRAWINGS

FIG. 1 provides thermal stability data of a safflower yellow lake as prepared herein.

FIG. 2 provides light stability data of a safflower yellow lake as prepared herein.

### DETAILED DESCRIPTION

In the specification and in the claims, the terms “including” and “comprising” are open-ended terms and should be interpreted to mean “including, but not limited to . . . ” These terms encompass the more restrictive terms “consisting essentially of” and “consisting of:”

It must be noted that as used herein and in the appended claims, the singular forms “a”, “an”, and “the” include plural reference unless the context clearly dictates otherwise. As well, the terms “a” (or “an”), “one or more” and “at least one” can be used interchangeably herein. It is also to be noted that the terms “comprising”, “including”, “characterized by” and “having” can be used interchangeably.

Unless defined otherwise, all technical and scientific terms used herein have the same meanings as commonly understood by one of ordinary skill in the art to which this invention belongs. All publications and patents specifically mentioned herein are incorporated by reference in their entirety for all purposes including describing and disclosing the chemicals, instruments, statistical analyses and methodologies which are reported in the publications which might be used in connection with the invention. All references cited in this specification are to be taken as indicative of the level of skill in the art. Nothing herein is to be construed as an admission that the invention is not entitled to antedate such disclosure by virtue of prior invention.

In a particularly preferred embodiment, the food coloring substance is an extract of saffron, safflower, or gardenia extract.

In one aspect, the compositions described herein are used with food colorants and is to be understood as substances which may be added to food products, sweets, confectionary, beverages, pharmaceuticals and similar other products to be ingested orally.

Likewise, food products in the present context is to be understood as any edible product comprising nutrients, sweets, confectionary, beverages and pharmaceuticals.

The term aluminium lake denotes herein a type of coloring composition that includes a coloring substance, such as a plant yellow extract, combined more or less definitely with alumina (or an aluminum containing compound). An aluminum lake is prepared by combining the coloring substance with alumina (or an aluminum containing compound) under appropriate condition, such as aqueous conditions at low pH. The conditions can be adjusted to favor precipitation of the ultimate coloring composition. In certain aspects, the “lake” may further include a calcium compound in addition to the aluminum containing compound. In other aspects, the “lake” may further include a ferric ion-containing compound in addition to the aluminum compound or in place of the aluminum compound, optionally, in the presence of a calcium compound.

A further aspect of the invention provides a process for producing a food coloring substance (e.g. a food coloring substance), having a yellow color at a pH in the range of from about 2 to about 6, which process comprises treating a food coloring substance which contains a plant yellow extract compound (as further described herein) with an aluminium compound (or ferric ion-containing compound) optionally with a calcium compound, and adjusting the pH to a value of from about 2 to about 6, to produce an aluminium lake comprising the plant yellow extract compound.

A plant yellow extract-aluminum lake is prepared by a procedure, whereby an aluminium containing compound is combined with the food coloring substance, followed by adjustment of the pH to a value of from about 2 to about 6, preferably from about 3 to about 6, to cause precipitation of the lake. The pH values vary from at least above 2.

The adjustment of the pH can be done after the coloring substance has been combined with the aluminium compound, ferric ion-containing compound, and/or calcium containing compound. An example is a process wherein the food coloring substance is combined with a solution or suspension of an aluminium compound, and the pH is then maintained at or below a pH of about 6. Addition of a calcium compound can be included. Alternatively, the aluminum compound can be replaced with a ferric ion-containing compound.

In certain aspects, it has been surprisingly found that a large excess of an aluminum compound, e.g., about a 30 molar ratio of Al³⁺, in particular a provides an exceptional aluminum lake. Likewise, such lakes can be prepared with the addition of a calcium containing compound and/or the aluminum compound can be substituted with a ferric ion-containing compound in excess.

In one aspect the ratio of aluminum to a food coloring substance, such as a plant yellow extract, can be from about 0.01:1 to about 60:1, from about 0.1:1 to about 50:1, from about 0.2:1 to about 40:1, from about 0.5:1 to about 30:1, from about 0.75:1 to about 20:1 from about 1:1 to about 10:1 and all ranges therebetween including fractions thereof.

Suitable food coloring substances include a plant yellow extract that includes one or more of hydroxysafflor yellow A (safflomin A), or safflor yellow B (safflomin B), crocin, a monoester of crocetin or a diester of crocetin.

The sugar residues of the extract components are most commonly residues derived from glucose, galactose, xylose, arabinose and rhamnose; substitution with disaccharides also occurs e.g. rutinose, sophorose, sambubiose, and gentiobiose. These residues are examples only and are not to be understood as a complete list.

The term “plant yellow extract”, therefore encompasses water soluble pigments that are generally yellow in color, depending on pH. Plant yellow extracts can be glucosides or aglucosides. Suitable plant yellow extracts include, for example, saffron, safflower, or gardenia extract.

The phrase “specific plant yellow extract component(s)” refers to specific components within the extract such as hydroxysafflor yellow A (safflomin A), or safflor yellow B (safflomin B), crocin, a monoester of crocetin or a diester of crocetin.

The invention illustratively disclosed herein may suitably be practiced in the absence of any element which is not specifically disclosed herein.

The following paragraphs enumerated consecutively from 1 through 65 provide for various aspects of the present invention. In one embodiment, in a first paragraph (1), the present invention provides a coloring composition, comprising a food coloring substance which includes a plant yellow extract combined with an aluminum containing compound and a calcium containing compound to form an aluminum-containing compound.

2. The coloring composition of paragraph 1, wherein the food coloring substance is a plant yellow extract, derivatives thereof, condensation products thereof and hydrates thereof.

3. A coloring composition of paragraph 1 or 2, wherein the plant yellow extract compound is one or more of hydroxysafflor yellow A (safflomin A), or safflor yellow B (safflomin B), crocin, a monoester of crocetin or a diester of crocetin.

4. The coloring composition of any of paragraphs 1 through 3, wherein the plant yellow extract compound originates from plant parts other than petals or sepals.

5. The coloring composition of paragraph 4, wherein the food coloring substance is an extract of saffron, safflower, or gardenia extract.

6. The coloring composition of any of paragraphs 1 through 5, wherein the aluminum containing compound is an aluminum halide, aluminum sulfate, and/or a potassium aluminum sulfate.

7. The coloring composition of any of paragraphs 1 through 6, wherein the calcium containing compound is a calcium halide.

8. The coloring composition of any of paragraphs 1 through 7, wherein the molar ratio of aluminum containing compound to plant yellow extract is from about 1:1 to about 60:1.

9. A coloring composition, comprising a food coloring substance which includes a plant yellow extract combined with a molar excess of aluminum containing compound to form an aluminum-containing compound, wherein the molar excess of aluminum containing compound is at least 30 moles of aluminum containing compound to 1 mole of plant yellow extract.

10. The coloring composition of paragraph 9, wherein the food coloring substance is a plant yellow extract, derivatives thereof, condensation products thereof and hydrates thereof.

11. A coloring composition of paragraph 9 or 10, wherein the plant yellow extract compound is one or more of hydroxysafflor yellow A (safflomin A), or safflor yellow B (safflomin B), crocin, a monoester of crocetin or a diester of crocetin.

12. The coloring composition of any of paragraphs 9 through 11, wherein the plant yellow extract compound originates from plant parts other than petals or sepals.

13. The coloring composition of paragraph 12, wherein the food coloring substance is an extract of saffron, safflower, or gardenia extract.

14. The coloring composition of any of paragraphs 9 through 13, wherein the aluminum containing compound is an aluminum halide, aluminum sulfate, and/or potassium aluminum sulfate.

15. The coloring composition of any of paragraphs 9 through 14, wherein the molar ratio of aluminum containing compound to plant yellow extract is from about 1:1 to about 60:1.

16. The coloring composition of paragraph 15, wherein the molar ratio of aluminum containing compound to plant yellow extract is from about 1 to about 30.

17. A coloring composition, comprising a food coloring substance which includes a plant yellow extract combined with a molar excess of aluminum containing compound to form an aluminum-containing compound, wherein the molar excess of aluminum containing compound is at least 30 moles of aluminum containing compound to 1 mole of plant yellow extract and a calcium compound.

18. The coloring composition of paragraph 17, wherein the food coloring substance is a plant yellow extract, derivatives thereof, condensation products thereof and hydrates thereof.

19. A coloring composition of paragraph 17 or 18, wherein the plant yellow extract compound is one or more of hydroxysafflor yellow A (safflomin A), or safflor yellow B (safflomin B), crocin, a monoester of crocetin or a diester of crocetin.

20. The coloring composition of any of paragraphs 17 through 19, wherein the plant yellow extract compound originates from plant parts other than petals or sepals.

21. The coloring composition of paragraph 20, wherein the food coloring substance is an extract of saffron, safflower, or gardenia extract.

22. The coloring composition of any of paragraphs 17 through 21, wherein the aluminum containing compound is an aluminum halide, aluminum sulfate, and/or potassium aluminum sulfate.

23. The coloring composition of any of paragraphs 17 through 22, wherein the calcium containing compound is a calcium halide.

24. A coloring composition, comprising a food coloring substance which includes a plant yellow extract combined with ferric ion containing compound to form a ferric ion-containing compound, optionally in the presence of a calcium ion.

25. The coloring composition of paragraph 24, wherein the food coloring substance is a plant yellow extract, derivatives thereof, condensation products thereof and hydrates thereof.

26. A coloring composition of paragraph 24 or 25, wherein the plant yellow extract compound is one or more of hydroxysafflor yellow A (safflomin A), or safflor yellow B (safflomin B), crocin, a monoester of crocetin or a diester of crocetin.

27. The coloring composition of any of paragraphs 24 through 26, wherein the plant yellow extract compound originates from plant parts other than petals or sepals.

28. The coloring composition of paragraph 27, wherein the food coloring substance is an extract of saffron, safflower, or gardenia extract.

29. The coloring composition of any of paragraphs 24 through 28, wherein the ferric ion-containing compound is ferric ammonium sulfate.

30. The coloring composition of any of paragraphs 24 through 29, wherein the molar ratio of ferric ion-containing compound to plant yellow extract is from about 1:1 to about 30:1.

31. A coloring composition, comprising a food coloring substance which includes a plant yellow extract combined with a molar excess of ferric ion-containing compound to form an ferric ion-containing compound, wherein the molar excess of ferric ion-containing compound is at least 30 moles of ferric ion-containing compound to 1 mole of plant yellow extract.

32. The coloring composition of paragraph 31, wherein the food coloring substance is a plant yellow extract, derivatives thereof, condensation products thereof and hydrates thereof.

33. A coloring composition of paragraph 31 or 32, wherein the plant yellow extract compound is one or more of hydroxysafflor yellow A (safflomin A), or safflor yellow B (safflomin B), crocin, a monoester of crocetin or a diester of crocetin.

34. The coloring composition of any of paragraphs 31 through 33, wherein the plant yellow extract compound originates from plant parts other than petals or sepals.

35. The coloring composition of paragraph 34, wherein the food coloring substance is an extract of saffron, safflower, or gardenia extract.

36. The coloring composition of any of paragraphs 31 through 35, wherein the ferric ion-containing compound is ferric ammonium sulfate.

37. A coloring composition, comprising a food coloring substance which includes a plant yellow extract combined with a ferric ion-containing compound and a calcium containing compound to form a ferric ion-containing compound.

38. The coloring composition of paragraph 37, wherein the food coloring substance is a plant yellow extract, derivatives thereof, condensation products thereof and hydrates thereof.

39. A coloring composition of paragraph 37 or 38, wherein the plant yellow extract compound is one or more of hydroxysafflor yellow A (safflomin A), or safflor yellow B (safflomin B), crocin, a monoester of crocetin or a diester of crocetin.

40. The coloring composition of any of paragraphs 37 through 39, wherein the plant yellow extract compound originates from plant parts other than petals or sepals.

41. The coloring composition of paragraph 40, wherein the food coloring substance is an extract of saffron, safflower, or gardenia extract.

42. The coloring composition of any of paragraphs 37 through 41, wherein the ferric ion-containing compound is ferric ammonium sulfate.

43. The coloring composition of any of paragraphs 37 through 42, wherein the calcium containing compound is a calcium halide.

44. A coloring composition, comprising a food coloring substance which includes a plant yellow extract combined with a molar excess of ferric ion-containing compound and a calcium containing compound to form a ferric ion-containing compound.

45. The coloring composition of paragraph 44, wherein the food coloring substance is a plant yellow extract, derivatives thereof, condensation products thereof and hydrates thereof.

46. A coloring composition of paragraph 44 or 45, wherein the plant yellow extract compound is one or more of hydroxysafflor yellow A (safflomin A), or safflor yellow B (safflomin B), crocin, a monoester of crocetin or a diester of crocetin.

47. The coloring composition of any of paragraphs 44 through 46, wherein the plant yellow extract compound originates from plant parts other than petals or sepals.

48. The coloring composition of paragraph 47, wherein the food coloring substance is an extract of saffron, safflower, or gardenia extract.

49. The coloring composition of any of paragraphs 44 through 48, wherein the ferric ion-containing compound is ferric ammonium sulfate.

50. The coloring composition of any of paragraphs 44 through 49, wherein the calcium containing compound is a calcium halide.

51. The coloring composition of any of paragraphs 44 through 50, wherein the molar ratio of ferric ion-containing compound to plant yellow extract is from about 1:1 to about 30:1.

52. A coloring composition, comprising a food coloring substance which includes a plant yellow extract combined with an aluminum containing compound and a ferric ion-containing compound to form an aluminum-containing compound.

53. The coloring composition of paragraph 52, wherein the food coloring substance is a plant yellow extract, derivatives thereof, condensation products thereof and hydrates thereof.

54. A coloring composition of paragraph 52 or 53, wherein the plant yellow extract compound is one or more of hydroxysafflor yellow A (safflomin A), or safflor yellow B (safflomin B), crocin, a monoester of crocetin or a diester of crocetin.

55. The coloring composition of any of paragraphs 52 through 54, wherein the plant yellow extract compound originates from plant parts other than petals or sepals.

56. The coloring composition of paragraph 55, wherein the food coloring substance is an extract of saffron, safflower, or gardenia extract.

57. The coloring composition of any of paragraphs 52 through 56, wherein the aluminum containing compound is an aluminum halide, aluminum sulfate, and/or potassium aluminum sulfate.

58. The coloring composition of any of paragraphs 52 through 57, wherein the ferric ion-containing compound is ferric ammonium hydroxide.

59. A coloring composition, comprising a food coloring substance which includes a plant yellow extract combined with an aluminum containing compound, a ferric ion-containing compound and a calcium containing compound to form an aluminum-containing compound.

60. The coloring composition of paragraph 59, wherein the food coloring substance is a plant yellow extract, derivatives thereof, condensation products thereof and hydrates thereof.

61. A coloring composition of paragraph 59 or 60, wherein the plant yellow extract compound is one or more of hydroxysafflor yellow A (safflomin A), or safflor yellow B (safflomin B), crocin, a monoester of crocetin or a diester of crocetin.

62. The coloring composition of any of paragraphs 59 through 60, wherein the plant yellow extract compound originates from plant parts other than petals or sepals.

63. The coloring composition of paragraph 62, wherein the food coloring substance is an extract of saffron, safflower, or gardenia extract.

64. The coloring composition of any of paragraphs 59 through 63, wherein the aluminum containing compound is an aluminum halide, aluminum sulfate, and/or potassium aluminum sulfate.

65. The coloring composition of any of paragraphs 59 through 64, wherein the ferric ion-containing compound is ferric ammonium hydroxide.

The following paragraphs enumerated consecutively from 1 through 16 also provide for various aspects of the present invention. In one embodiment, in a first paragraph (1), the present invention provides a coloring composition, comprising a food coloring substance which includes a plant yellow extract combined with an aluminum containing compound to form an aluminum plant yellow extract containing compound.

2. The coloring composition of paragraph 1, wherein the food coloring substance is a plant yellow extract, derivatives thereof, condensation products thereof and hydrates thereof.

3. A coloring composition of paragraph 1 or 2, wherein the plant yellow extract compound is one or more of hydroxysafflor yellow A (safflomin A), or safflor yellow B (safflomin B), crocin, a monoester of crocetin or a diester of crocetin.

4. The coloring composition of any of paragraphs 1 through 3, wherein the plant yellow extract compound originates from plant parts other than petals or sepals.

5. The coloring composition of paragraph 4, wherein the food coloring substance is an extract of saffron, safflower, or gardenia extract.

6. The coloring composition of any of paragraphs 1 through 5, wherein the aluminum containing compound is an aluminum halide, aluminum sulfate, and/or a potassium aluminum sulfate

7. The coloring composition of any of paragraphs 1 through 6, wherein the molar ratio of aluminum containing compound to plant yellow extract is from about 0.1:1 to about 60:1.

8. A coloring composition, comprising a food coloring substance which includes a plant yellow extract combined with an aluminum containing compound to form an aluminum plant yellow extract containing compound, wherein the molar excess of aluminum containing compound is at least 30 moles of aluminum containing compound to 1 mole of plant yellow extract.

9. The coloring composition of paragraph 8, wherein the food coloring substance is a plant yellow extract, derivatives thereof, condensation products thereof and hydrates thereof.

10. A coloring composition of paragraph 8 or 9, wherein the plant yellow extract compound is one or more of hydroxysafflor yellow A (safflomin A), or safflor yellow B (safflomin B), crocin, a monoester of crocetin or a diester of crocetin.

11. The coloring composition of any of paragraphs 8 through 10, wherein the plant yellow extract compound originates from plant parts other than petals or sepals.

12. The coloring composition of paragraph 11, wherein the food coloring substance is an extract of saffron, safflower, or gardenia extract.

13. The coloring composition of any of paragraphs 8 through 12, wherein the aluminum containing compound is an aluminum halide, aluminum sulfate, and/or potassium aluminum sulfate.

14. The coloring composition of any of paragraphs 9 through 14, wherein the molar ratio of aluminum containing compound to plant yellow extract is from about 40:1 to about 60:1.

15. The coloring composition of paragraph 14, wherein the molar ratio of aluminum containing compound to plant yellow extract is from about 50:1 to about 100:1.

16. The coloring composition of any of paragraphs 1 through 15, wherein the yellow plant extract has a conjugated unsaturated or polyunsaturated hydrocarbon chain adjacent to a carbonyl moiety.

The invention will be further described with reference to the following non-limiting Examples. It will be apparent to those skilled in the art that many changes can be made in the embodiments described without departing from the scope of the present invention. Thus the scope of the present invention should not be limited to the embodiments described in this application, but only by embodiments described by the language of the claims and the equivalents of those embodiments. Unless otherwise indicated, all percentages are by weight.

### EXAMPLES

2.0 g safflower extract (E1% 140)(E=chroma, 1% is concentration, 140 is the chroma value) was added into 50 ml water with complete stirring, and then 0.276 g AlCl₃ (12 equiv in mol) was put into the solution. The pH of the solution was adjusted with ammonia to 4.25, 5.00, 6.00, 6.50 respectively in four separate samples. The mixtures were stirred for 1 hour at room temperature and then centrifuged to provide solids. The solids were spray dried to yield yellow powders 0.212 g, 0.431 g, 0.650 g and 0.410 g respectively.

### POSSIBLE EXAMPLES

Example

| | 1 | 2 | 3 | 4 | 5 | 6 |
|---|---|---|---|---|---|---|
| Yellow | | | | | | |
| Al | | | | | | |
| Ca | | | | | | |
| Fe | | | | | | |

According to the example above, each example above will use the components noted below for the preparation of “yellow” lake. ( denotes material included in the proposed preparations).

1) hydroxysafflor yellow A (safflomin A),

2) safflor yellow B (safflomin B)

3) crocin

4) a monoester of crocetin

5) a diester of crocetin

6) mixture of above anyone or more.

In each example, the molar ratio of Al/Fe to yellow would be fixed according to below three points:

60:1

30:1 and

1:1.

Wherein the addition of Ca is about 0-2.5 times (mole) of Al/Fe.

Al=aluminum halide, aluminum sulfate, and/or potassium aluminum sulfate.

Ca=calcium halide.

Fe=ferric ammonium sulfate.

### Examples 1-3

### Preparation of Safflower Yellow Lake

Safflower yellow extract (E1%=140 (E=chroma, 1% is the concentration, 140 is the chroma value), Wuhan Green Food Biological Engineering Co. Ltd., WGFS110121) (The extract is a mixture of various components, therefore the calculation of the exact mole percentage is difficult. The mole percentage is based on the main components of the extract, safflomin A and safflomin B which provide approximately 10 weight percent of the raw material. This was used as the standard to calculate the moles of substance.) was dissolved in 50 ml purified water with stirring to obtain a safflower yellow extract solution. AlCl₃ was dissolved in 20 ml purified water to obtain an AlCl₃ solution. The AlCl₃ solution was slowly added into the safflower yellow extract solution at room temperature with stirring to obtain a mixed solution. The pH of the mixed solution was adjusted to 5.0 with ammonia and a suspended solid formed. The system was further stirred for 1 h at room temperature and then was centrifuged to provide a solid. The solid was washed with purified water for 3 times, and then was suspended in purified water. The suspension was spray dried, and the final product was weighed and the chroma was determined.

The conditions of the preparation process and the properties of the final product are summarized in Table 1.

TABLE 1

| | | | Mole | | | |
|---|---|---|---|---|---|---|
| | | | ratio of | | | |
| | | | AlCl₃ to | | | |
| | Safflower yellow | | Safflower | | | |
| | extract | AlCl₃ | yellow | Chroma | Suspensibility | Yield |
| Example | (g/mmol) | (g/mmol) | extract | (E1%) | (in water/oil) | (g) |
| 1 | 1.5 g/0.25 mmol* | 1.60 g/ | 48 | 100 | Good** | 1.41 |
| | | 12 mmol | | | | |
| 2 | 2.00 g/0.325 mmol* | 0.80 g/ | 18.46 | 150 | Good | 1.11 |
| | | 6 mmol | | | | |
| 3 | 2.00 g/0.325 mmol* | 0.26 g/ | 6 | 202.8 | Good | 0.59 |
| | | 1.95 mmol | | | | |

*calculated as safflomin A and safflomin B
**Comparable with commercially available Allura Red lake

### Example 4

### Thermal Stability of Safflower Yellow Lake

The safflower yellow lake prepared in example 3 (E1%=202.8) was put in a dryer at 80° C., 100° C. and 120° C., respectively. Test samples were collected at 1 hour intervals over 6 hours, and the chroma of each sample was determined in aqueous phosphoric acid solution (pH=1.0).

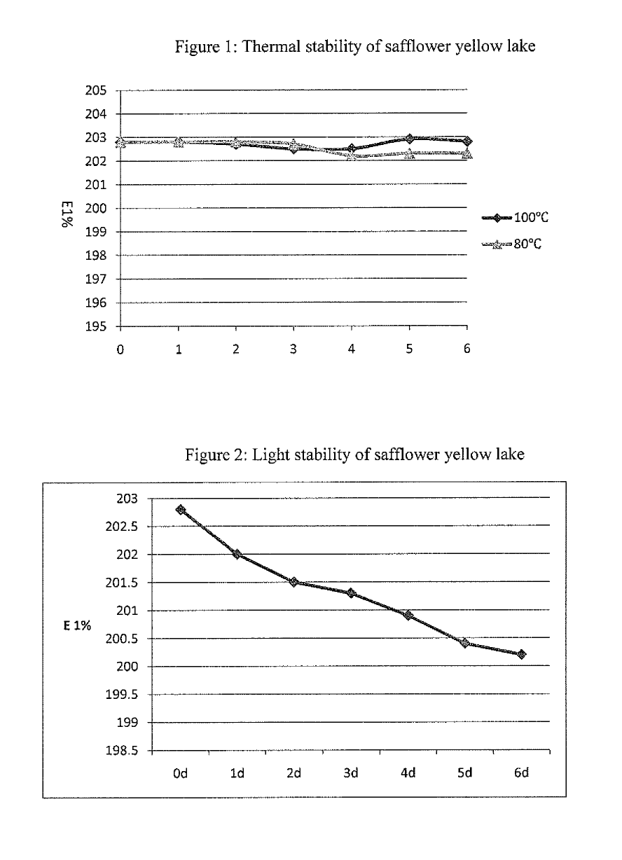

The results were summarized in Table 2 and FIG. 1. The results showed that safflower yellow lake prepared in example 3 is stable at high temperature.

TABLE 2
Thermal stability of safflower yellow lake

| Time | Chroma | | |
|---|---|---|---|
| (h) | 80° C. | 100° C. | 120° C. |
| 0 | 202.8 | 202.8 | 202.8 |
| 1 | 202.8 | 202.8 | 212.2 |
| 2 | 202.8 | 202.7 | 210.7 |
| 3 | 202.7 | 202.5 | 208.3 |
| 4 | 202.2 | 202.5 | 204.4 |
| 5 | 202.3 | 202.9 | 202.5 |
| 6 | 202.3 | 202.8 | 202.3 |

### Example 5

### Light Stability of Safflower Yellow Lake

The safflower yellow lake prepared in example 3 (E1%=202.8) was exposed to sunlight at room temperature. Test samples were collected at 1 day intervals, and the chroma of each sample was determined in an aqueous phosphoric acid solution (pH=1.0).

The results were summarized in Table 3 and FIG. 2. The results showed that safflower yellow lake prepared in example 3 is stable while exposed to sunlight.

TABLE 3
Light stability of safflower yellow lake

| Time(day) | Chroma |
|---|---|
| 0 | 202.8 |
| 1 | 202.0 |
| 2 | 201.5 |
| 3 | 201.3 |
| 4 | 200.9 |
| 5 | 200.4 |
| 6 | 200.2 |

### Example 6

### Preparation of Gardenia Yellow Lake

2.0 g gardenia yellow extract (E1%=96.3, provided by Wuhan Green Food Biological Engineering Co. Ltd, lot 2012-0111-05) (0.6 mmol, calculated as crocin and crocetin) was dissolved in 30 ml purified water with stirring to obtain a gardenia yellow extract solution. 0.8 g AlCl₃ (6 mmol) was dissolved in 20 ml purified water to obtain an AlCl₃ solution. The AlCl₃ solution was slowly added into the gardenia yellow extract solution at room temperature with stirring to obtain a mixed solution. The pH of the mixed solution was adjusted to 5.0 with ammonia and a suspended solid formed. The system was further stirred for 1 h at room temperature and then was centrifuged to provide a solid. The solid was washed with purified water for 3 times, and then was suspended in purified water. The suspension was spray dried to obtain 0.8 g solid gardenia yellow lake, E1%=69.

Although the present invention has been described with reference to preferred embodiments, persons skilled in the art will recognize that changes may be made in form and detail without departing from the spirit and scope of the invention. All references cited throughout the specification, including those in the background, are incorporated herein in their entirety. Those skilled in the art will recognize, or be able to ascertain, using no more than routine experimentation, many equivalents to specific embodiments of the invention described specifically herein. Such equivalents are intended to be encompassed in the scope of the following claims.

What is claimed is:

1. A coloring composition, comprising a food coloring substance which includes a plant yellow extract combined with an aluminum containing compound to form an aluminum plant yellow extract containing compound.

2. The coloring composition of claim 1, wherein the food coloring substance is a plant yellow extract, derivatives thereof, condensation products thereof and hydrates thereof.

3. A coloring composition of claim 1, wherein the plant yellow extract compound is one or more of hydroxysafflor yellow A (safflomin A), or safflor yellow B (safflomin B), crocin, a monoester of crocetin or a diester of crocetin.

4. The coloring composition of claim 1, wherein the plant yellow extract compound originates from plant parts other than petals or sepals.

5. The coloring composition of claim 4, wherein the food coloring substance is an extract of saffron, safflower, or gardenia extract.

6. The coloring composition of claim 1, wherein the aluminum containing compound is an aluminum halide, aluminum sulfate, and/or a potassium aluminum sulfate.

7. The coloring composition of claim 1, wherein the molar ratio of aluminum containing compound to plant yellow extract is from about 0.1:1 to about 60:1.

8. A coloring composition, comprising a food coloring substance which includes a plant yellow extract combined with an aluminum containing compound to form an aluminum plant yellow extract containing compound, wherein the molar excess of aluminum containing compound is at least 30 moles of aluminum containing compound to 1 mole of plant yellow extract.

9. The coloring composition of claim 8, wherein the food coloring substance is a plant yellow extract, derivatives thereof, condensation products thereof and hydrates thereof.

10. A coloring composition of claim 8, wherein the plant yellow extract compound is one or more of hydroxysafflor yellow A (safflomin A), or safflor yellow B (safflomin B), crocin, a monoester of crocetin or a diester of crocetin.

11. The coloring composition of claim 8, wherein the plant yellow extract compound originates from plant parts other than petals or sepals.

12. The coloring composition of claim 11, wherein the food coloring substance is an extract of saffron, safflower, or gardenia extract.

13. The coloring composition of any of claim 8, wherein the aluminum containing compound is an aluminum halide, aluminum sulfate, and/or potassium aluminum sulfate.

14. The coloring composition of any of claim 8, wherein the molar ratio of aluminum containing compound to plant yellow extract is from about 40:1 to about 60:1.

15. The coloring composition of claim 14, wherein the molar ratio of aluminum containing compound to plant yellow extract is from about 50:1 to about 100:1.

16. The coloring composition of claim 1, wherein the yellow plant extract has a conjugated unsaturated or polyunsaturated hydrocarbon chain adjacent to a carbonyl moiety.

17. The coloring composition of claim 8, wherein the yellow plant extract has a conjugated unsaturated or polyunsaturated hydrocarbon chain adjacent to a carbonyl moiety.

18. The coloring composition of claim 7, wherein the yellow plant extract has a conjugated unsaturated or polyunsaturated hydrocarbon chain adjacent to a carbonyl moiety.

19. The coloring composition of claim 3, wherein the yellow plant extract has a conjugated unsaturated or polyunsaturated hydrocarbon chain adjacent to a carbonyl moiety.

20. The coloring composition of claim 15, wherein the yellow plant extract has a conjugated unsaturated or polyunsaturated hydrocarbon chain adjacent to a carbonyl moiety.
